(19) United States
(12) Patent Application Publication
(10) Pub. No.: US 2023/0324708 A1
(43) Pub. Date: Oct. 12, 2023

(54) IMAGE PROJECTION DEVICE AND VEHICLE INFORMATION DISPLAY DEVICE

(71) Applicant: KOITO MANUFACTURING CO., LTD., Tokyo (JP)

(72) Inventor: Takashi MIYAZAKI, Shizuoka (JP)

(21) Appl. No.: 18/042,398

(22) PCT Filed: Oct. 1, 2021
(86) PCT No.: PCT/JP2021/036378

§ 371 Date: Feb. 21, 2023

(30) Foreign Application Priority Data
Oct. 5, 2020 (JP) 2020-168476

(51) Int. Cl. G02B 30/56; G02B 27/01; G02F 1/29; B60K 35/00

(52) U.S. Cl. CPC G02B 30/56; G02B 27/0101; G02F 1/29; B60K 35/00; G02B 2027/0134; B60K 2370/1529; B60K 2370/23; B60K 2370/29

(57) ABSTRACT

An image projection apparatus and a vehicle information display apparatus are provided which can suppress deterioration in an image display unit due to light from outside. An image projection apparatus (100) including: a projection optical unit (20) configured to project light from a focal position (F); and an image display unit (10) configured to apply light including image information to the projection optical unit (20), in which the image display unit (10) is placed farther from the projection optical unit (20) than the focal position (F) is, and forms an image of the image information as an aerial three-dimensional image (TI) at an image forming position between the focal position (F) and the projection optical unit (20).

### TECHNICAL FIELD

The present invention relates to an image projection apparatus, and particularly relates to an image projection apparatus and a vehicle information display apparatus that display an image for, for example, a driver in a vehicle.

### BACKGROUND ART

In recent years, development is underway for a driver assistance technology and a self-driving technology in which a computer is responsible for a part or all of driving operations such as steering and acceleration/deceleration of a vehicle. Moreover, in manual driving in which a person performs driving operations of a vehicle, a driving support technology has also been developed which uses a plurality of various sensors and communication devices mounted on a vehicle to obtain information on the state and surrounding conditions of the vehicle and to increase safety and comfort while driving the vehicle.

In such a driver assistance technology, self-driving technology, or driving support technology, various kinds of information obtained, such as the state and surrounding conditions of a vehicle and the driving operation state of a computer, are presented to the occupant by means of, for example, an image. A conventional and common way to present various kinds of information is to mount an image display apparatus on a vehicle and display characters and images on the image display apparatus.

However, if the image display apparatus provided in the vehicle presents information, the occupant and the driver need to look away from ahead in the travel direction and look at the image display apparatus, which is not preferable. Hence, a Head Up Display (HUD) apparatus has been proposed which projects an image on the windshield of a vehicle and allows the occupant and the driver to view the reflected light in order to present image information while reducing the movement of the eyes from ahead of the vehicle (refer to, for example, Patent Document 1).

FIGS. 7(a) and 7(b) are diagrams schematically illustrating an image forming position of a virtual image displayed, in a known HUD apparatus. In FIGS. 7(a) and 7(b), the configuration of the HUD apparatus is illustrated in a simplified manner, and members such as the windshield of a vehicle, and a flat plate-shaped mirror are omitted. As illustrated in FIGS. 7(a) and 7(b), in the known HUD apparatus, an image display unit 1 displays an image, and applies light including image information to a projection optical unit 2. The light that has traveled via the projection optical unit 2 forms a virtual image IM at a predetermined position. A known device such as a liquid crystal display device or an organic EL element is used for the image display unit 1. The projection optical unit 2 uses a concave mirror in which a focal point F is set at a focal length DF. Here, a reflective optical system that reflects light appears as the projection optical unit 2. However, the same applies to a case where a transmission optical system such as an optical lens is used.

As illustrated in FIG. 7(a), in the HUD apparatus, when a distance DD from the image display unit 1 to the projection optical unit 2 is set to be less than the focal length DF and the image display unit 1 is placed between the focal point F and the projection optical unit 2, the virtual image IM is formed at a position at a projection distance D_{IM} from the projection optical unit 2. The projection optical unit 2 applies light from the position of the focal point F, as parallel light. Therefore, the virtual image IM is formed at infinity when the image display unit 1 is placed at the position of the focal point F. Therefore, as illustrated in FIG. 7(b), as the image display unit 1 is brought closer to the focal point F, the projection distance D_{IM} from the projection optical unit 2 is increased to form the virtual image IM in the distance.

In the HUD apparatus, when the virtual image IM projected through a transparent member such as the windshield is viewed, the background of a real space and the virtual image IM are superimposed. At this point in time, as the depth positions of the background and the virtual image IM are closer to each other, the movement of the eyes and a change in the focal length of the eye can be reduced. Therefore, it is preferable to change the image forming position of the virtual image IM to the same depth position as the background where the virtual image IM is superimposed. In particular, in an HUD apparatus mounted on a vehicle, a preferable image forming position depends on the travel speed, and an image forming position of approximately 5 m is preferable at 18 km/h, and an image forming position of approximately 80 m is preferable at 144 km/h. Moreover, there is also a case where the virtual image IM is superimposed over a preceding vehicle or an object on the road, depending on the travel conditions of the vehicle. Therefore, it is required to make the image forming position of the virtual image IM variable in a wide range.

### CITATION LIST

### Patent Literature

Patent Document 1: JP-A-2019-119262

### SUMMARY OF INVENTION

### Problems to be Solved by Invention

As illustrated in FIGS. 7(a) and 7(b), it is effective to provide a drive unit that makes the distance between the image display unit 1 and the projection optical unit 2 variable to make the image forming position of the virtual image IM variable in the HUD apparatus. However, problems such as described below occur.

The projection optical unit 2 is optically designed to apply light from the focal point F as parallel light, although conversely concentrating, at the focal point F, light from a distance that is applied from outside. Specifically, sunlight can be regarded as parallel light applied from infinity. Therefore, extremely strong light is applied to the focal point F in an environment where sunlight is applied to the projection optical unit 2. In particular, in an HUD apparatus mounted on a vehicle, the windshield reflects the projected light so that the occupant views the virtual image IM. Therefore, there is a high possibility that sunlight is directly incident on the projection optical unit 2.

When the sunlight is directly incident on the projection optical unit 2 in this manner, if the image display unit 1 is brought closer to the focal point F to form the virtual image IM in the distance, the concentrated sunlight is incident on the display surface of the image display unit 1, which causes the temperature to rise. Consequently, it results in deterioration in the image display unit 1 and in a displayed image.

Hence, the present invention has been made considering the above known problems, and an object thereof is to provide an image projection apparatus and a vehicle information display apparatus that can suppress deterioration in an image display unit due to light from outside.

### Solution to Problems

In order to solve the above problems, an image projection apparatus of the present invention includes: a projection optical unit configured to project light from a focal position; and an image display unit configured to apply light including image information to the projection optical unit, in which the image display unit is placed farther from the projection optical unit than the focal position is, and forms an image of the image information as an aerial three-dimensional image at an image forming position between the focal position and the projection optical unit.

In such an image projection apparatus of the present invention, the image display unit is placed farther than the focal position of the projection optical unit, and the image display unit forms the aerial three-dimensional image between the focal position and the projection optical unit. Therefore, it is possible to prevent light from outside from being concentrated in the vicinity of the image display unit and to suppress deterioration in the image display unit due to the light from outside.

Moreover, in one aspect of the present invention, an image forming position change unit configured to change a distance between the image forming position and the focal position is included.

Moreover, in one aspect of the present invention, the image forming position change unit includes a drive unit that moves the image display unit in an optical axis direction.

Moreover, in one aspect of the present invention, the image forming position change unit includes an optical change unit that changes a distance between the image display unit and the image forming position.

Moreover, in one aspect of the present invention, the optical change unit includes a liquid crystal lens that changes the refractive index with applied voltage.

Moreover, in one aspect of the present invention, the optical change unit includes a hologram projection unit that uses a digital mirror device.

Moreover, in one aspect of the present invention, the projection optical unit includes a transmission lens.

Moreover, in one aspect of the present invention, the projection optical unit includes a concave reflector.

Moreover, in one aspect of the present invention, a light shielding unit that shields light is provided between the image display unit and the focal position.

Moreover, in one aspect of the present invention, the image display unit avoids the light shielding unit and forms the aerial three-dimensional image at the image forming position.

Moreover, in order to solve the above problems, a vehicle information display apparatus of the present invention includes the image projection apparatus according to any of the above.

### Effects of Invention

The present invention can provide an image projection apparatus and a vehicle information display apparatus that can suppress deterioration in an image display unit due to light from outside.

### BRIEF DESCRIPTION OF DRAWINGS

FIG. 1 is a schematic diagram illustrating the configuration of an image projection apparatus 100 according to a first embodiment.

FIG. 2 is a schematic diagram illustrating an example of changing an image forming position of an aerial three-dimensional image TI by using a drive unit that moves an image display unit 10 mechanically as an image forming position change unit.

FIG. 3 is a schematic diagram illustrating an example of changing an image forming position of an aerial three-dimensional image TI by means of a transmission liquid crystal lens and an optical change unit in an image projection apparatus 100 according to a second embodiment.

FIG. 4 is a schematic diagram illustrating an example of changing an image forming position of an aerial three-dimensional image TI by means of a liquid crystal microlens array and an optical change unit in an image projection apparatus 100 according to a modification of the second embodiment.

FIG. 5 is a schematic diagram illustrating an example of changing an image forming position of an aerial three-dimensional image TI by means of a hologram projection unit that uses a digital mirror device in an image projection apparatus 100 according to a third embodiment.

FIG. 6 is a schematic diagram illustrating the reflection of a reflected beam LR and a transmitted beam LT from a digital mirror device 18.

FIGS. 7(a) and 7(b) are diagrams schematically illustrating an image forming position of a virtual image displayed, in a known HUD apparatus.

### DESCRIPTION OF EMBODIMENTS

### First Embodiment

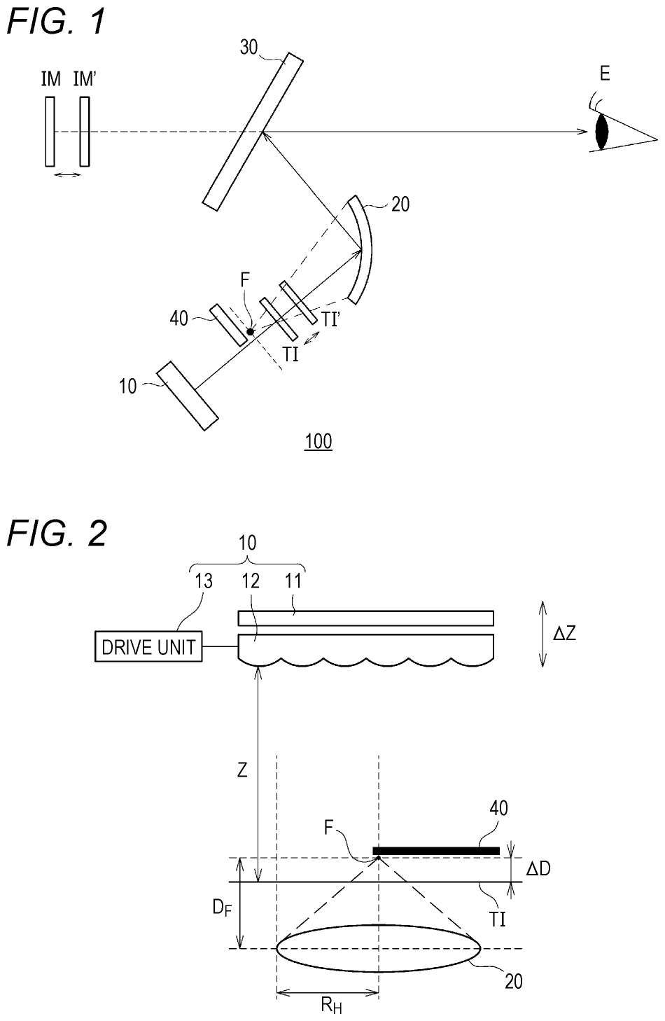

Embodiments of the present invention are described in detail hereinafter with reference to the drawings. The same reference signs are assigned to the same or equivalent components, members, and processes that are illustrated in the drawings, and overlapping descriptions thereof are omitted as appropriate. FIG. 1 is a schematic diagram illustrating the configuration of an image projection apparatus 100 according to the embodiment. As illustrated in FIG. 1, the image projection apparatus 100 includes an image display unit 10, a projection optical unit 20, a transmission screen unit 30, and a light shielding unit 40.

The image display unit 10 is a device that is supplied with power and signals from the outside and thereby applies light including image information to form an aerial three-dimensional image TI at a predetermined position. The light applied from the image display unit 10 is incident on the projection optical unit 20 after forming the aerial three-dimensional image TI. Examples of the image display unit 10 include a combination of a liquid crystal display device, an organic EL display device, a micro LED display device, a projector device that uses a laser light source, or the like, and an optical member.

The projection optical unit 20 is an optical member having a focal point F at a position that is a predetermined focal length DF away from the projection optical unit 20. The light applied from the image display unit 10 reaches the transmission screen unit 30 via the projection optical unit 20. FIG. 1 illustrates an example in which a concave mirror is used as the projection optical unit 20 and the light from the image display unit 10 is reflected on the transmission screen unit 30. However, a transmission lens may be used as the projection optical unit 20. Moreover, FIG. 1 illustrates an example in which the light applied from the image display unit 10 reaches the projection optical unit 20 directly. However, it may be configured in such a manner that light reflected by using, for example, a planar reflector reaches the projection optical unit 20.

The transmission screen unit 30 is a member that transmits light from the outside and reflects the light that has reached from the projection optical unit 20, toward a viewer E. If the image projection apparatus 100 is used for a vehicle information display apparatus, the windshield of a vehicle can be used as the transmission screen unit 30. A combiner may be provided separately from the windshield to be used as the transmission screen unit 30. Moreover, the shield of a helmet, goggles, or eyeglasses may be used as the transmission screen unit 30.

The light shielding unit 40 is a member that is placed between the projection optical unit 20 and the image display unit 10, and is made of a material that shields light. The light shielding unit 40 is provided to prevent light from the outside from being incident on and reflected by the projection optical unit 20 and then reaching the image display unit 10. The light shielding unit 40 is placed at a position where at least a part of the outside light is shielded. In the example illustrated in FIG. 1, the light shielding unit 40 is placed at a position slightly closer to the image display unit 10 than the focal point F is, and is placed in such a manner that the focal point F is concealed from the image display unit 10 to shield the outside light that spreads out and travels toward the image display unit 10 after being concentrated at the focal point F. The material that the light shielding unit 40 is made of is not limited, and a known material such as metal, resin, or ceramic can be used. FIG. 1 illustrates a flat plate shape as the light shielding unit 40. However, the light shielding unit 40 may have a curved shape or a concavo-convex shape as long as it can shield light.

As illustrated in FIG. 1, in the image projection apparatus 100, the image display unit 10 applies the light including the image information toward the projection optical unit 20, avoiding the light shielding unit 40. The light emitted from the image display unit 10 is reflected by the projection optical unit 20 and the transmission screen unit 30 after forming the aerial three-dimensional image TI, and enters the eyes of the viewer E. At this point in time, an image forming position of the aerial three-dimensional image TI is a position that is closer to the projection optical unit 20 than the focal point F is, and the viewer E views the virtual image IM through the transmission screen unit 30 in accordance with the distance from the focal point F. Moreover, when the image display unit 10 is controlled to change an image forming position of an aerial three-dimensional image TI′ and then to increase the distance from the focal point F, an image forming position of a virtual image IM′ changes in such a manner as to move closer to the viewer E.

At this point in time, when strong light such as sunlight is incident on the projection optical unit 20 from outside, the outside light is concentrated from the projection optical unit 20 toward the focal point F as indicated by a broken line in FIG. 1. However, the image display unit 10 is not placed between the projection optical unit 20 and the focal point F, but is placed farther from the projection optical unit 20 than the focal point F is. Consequently, it is possible to place the image display unit 10 at a position away from the focal point F, and to prevent a temperature rise and deterioration due to concentration of the outside light.

In the image projection apparatus 100 of the embodiment, an image forming position of the virtual image IM that is viewed by the viewer E can be changed according to a distance between the image forming position of the aerial three-dimensional image TI and the focal point F. Therefore, simply by bringing the aerial three-dimensional image TI closer to the focal point F, the virtual image IM can be formed in the distance, and the virtual image IM superimposed over the background is excellently visible. At this point in time, even if the outside light is concentrated at the focal point F, the aerial three-dimensional image TI is not affected by heat. Therefore, it is possible to form the virtual image IM in the distance and increase visibility even in an environment where strong sunlight reaches the projection optical unit 20.

Moreover, the light shielding unit 40 that shields light is provided between the image display unit 10 and the focal point F. Therefore, even if the outside light is incident on the projection optical unit 20 and concentrated at the focal point F, the outside light that spreads out and travels from the focal point F toward the image display unit 10 is effectively shielded, and it is possible to suppress a temperature rise due to the outside light reaching the image display unit 10. If the light shielding unit 40 is placed slightly closer to the image display unit 10 than the focal point F is and the focal point F is concealed from the image display unit 10, most of the light concentrated at the focal point F can be shielded by the light shielding unit 40, which is preferable.

However, even if all the outside light concentrated at the focal point F cannot be shielded by the light shielding unit 40 and a part of the concentrated outside light travels toward the image display unit 10, at least a part of the energy of the light that reaches the image display unit 10 can be reduced. Therefore, a temperature rise in the image display unit 10 can be suppressed. Moreover, the image display unit 10 is placed at a position farther from the projection optical unit 20 than the focal point F is. Therefore, the light concentrated at the focal point F increases in diameter and reaches the image display unit 10. Therefore, even if strong outside light reaches a part of the image display unit 10, it is possible to suppress a local temperature rise.

As illustrated in FIG. 1, in the image projection apparatus 100 and the vehicle information display apparatus of the embodiment, the image forming position of the virtual image IM can be changed by changing the image forming position of the aerial three-dimensional image TI. Hence, the image projection apparatus 100 includes an image forming position change unit that changes the distance between the image forming position of the aerial three-dimensional image TI by the image display unit 10 and the focal point F, and makes the image forming positions of the aerial three-dimensional image TI and the virtual image IM variable.

FIG. 2 is a schematic diagram illustrating an example of changing the image forming position of the aerial three-dimensional image TI by using a drive unit that moves the image display unit 10 mechanically as the image forming position change unit.

The image display unit 10 includes a display surface 11 and a three-dimensional image projection unit 12, and is configured in such a manner as to be movable in an optical axis direction by a drive unit 13. The drive unit 13 is a device that mechanically changes the distance between the image forming position of the aerial three-dimensional image TI and the focal point F, and corresponds to the image forming position change unit in the present invention. Here, the optical axis direction of the image display unit 10 is a direction in which the light applied from the image display unit 10 forms the aerial three-dimensional image TI and travels to the projection optical unit 20. As an example, the optical axis direction of the image display unit 10 is a direction along an arrow that is drawn from the image display unit 10 to the projection optical unit 20 in FIG. 1, and is a direction of a double-headed arrow that is drawn from the three-dimensional image projection unit 12 to the aerial three-dimensional image TI in FIG. 2.

The display surface 11 is a portion that displays an image on the basis of image information supplied from the outside and applies light. A known liquid crystal display device, organic EL display device, micro LED display device, or the like can be used as the display surface 11. The three-dimensional image projection unit 12 is an optical member for forming an image of light including image information applied from the display surface 11, as the aerial three-dimensional image TI, at a position at a predetermined distance. A microlens array or the like can be used as the three-dimensional image projection unit 12.

As illustrated in FIG. 2, the image displayed on the display surface 11 forms the aerial three-dimensional image TI at a position at an image forming distance Z through the three-dimensional image projection unit 12. As in FIG. 1, the aerial three-dimensional image TI is located between the projection optical unit 20 and the focal point F, and the image forming position of the aerial three-dimensional image TI and the position of the focal point F are a distance ΔD apart from each other. Moreover, the light shielding unit 40 is placed between the focal point F and the three-dimensional image projection unit 12, and blocks the travel of the outside light concentrated at the focal point F toward the display surface 11.

When the drive unit 13 moves the display surface 11 and the three-dimensional image projection unit 12 together at a time by ΔZ in the optical axis direction, a distance between the display surface 11 and the three-dimensional image projection unit 12, and the image forming distance Z are constant, and the image forming position of the aerial three-dimensional image TI also changes by ΔZ in the optical axis direction. Therefore, the distance ΔD between the aerial three-dimensional image TI and the focal point F also changes by ΔZ, and the image forming position of the virtual image IM also changes.

When the drive unit 13 moves one of the display surface 11 and the three-dimensional image projection unit 12 by ΔZ in the optical axis direction, the distance between the display surface 11 and the three-dimensional image projection unit 12 changes. Therefore, the image forming distance Z also changes, and the image forming position of the aerial three-dimensional image TI also changes by ΔZ′ in the optical axis direction. Therefore, the distance ΔD between the aerial three-dimensional image TI and the focal point F also changes by ΔZ′, and the image forming position of the virtual image IM also changes.

As described above, in the embodiment, the image display unit 10 is placed farther than the focal point F of the projection optical unit 20, and forms the aerial three-dimensional image TI between the focal point F and the projection optical unit 20. Therefore, it is possible to prevent light from outside from being concentrated in the vicinity of the image display unit 10 and to suppress deterioration in the image display unit 10 due to the light from outside.

Moreover, the drive unit 13 that moves the image display unit 10 mechanically is used as the image forming position change unit; therefore, the image forming position of the virtual image IM can be changed with a simple configuration. Moreover, the image display unit 10 does not need to be placed in the vicinity of the focal point F. Therefore, also if the distance ΔD between the aerial three-dimensional image TI and the focal point F is reduced to form the virtual image IM in the distance, it is possible to suppress a temperature rise in the image display unit 10 due to the concentration of the outside light.

### Second Embodiment

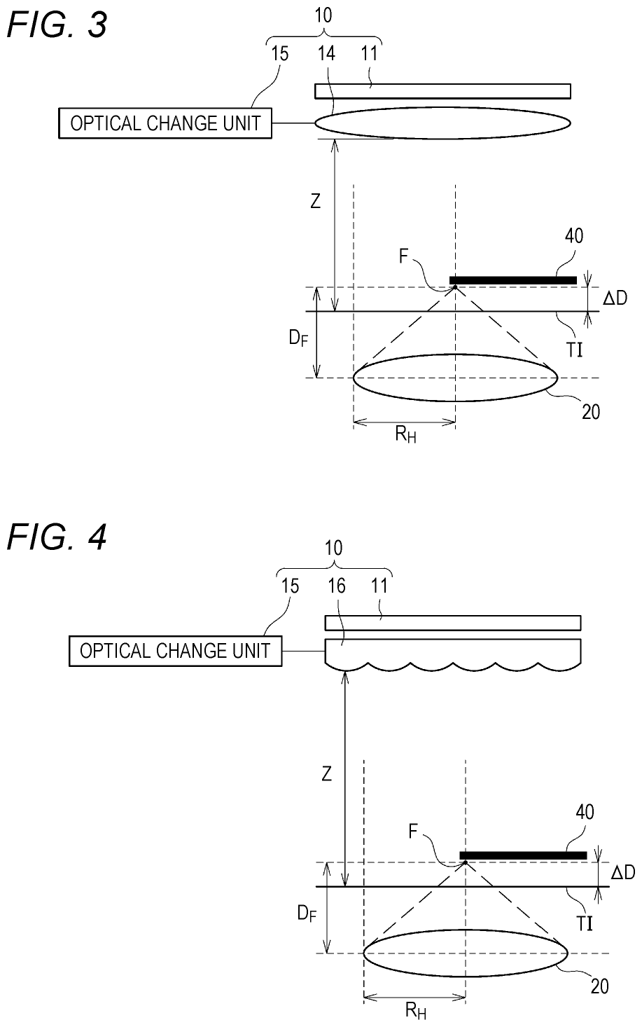

Next, a second embodiment of the present invention is described with reference to FIG. 3. Descriptions of contents overlapping with those of the first embodiment are omitted. FIG. 3 is a schematic diagram illustrating an example of changing the image forming position of the aerial three-dimensional image TI by means of a transmission liquid crystal lens and an optical change unit in the image projection apparatus 100 according to the embodiment. As illustrated in FIG. 3, in the image projection apparatus 100 of the embodiment, the image display unit 10 includes the display surface 11 and a liquid crystal lens 14, and is configured in such a manner that an optical change unit 15 can change the refractive index of the liquid crystal lens 14.

The liquid crystal lens 14 is a lens-shaped optical member filled with liquid crystal molecules. The refractive index of the liquid crystal molecules has anisotropy. Therefore, the liquid crystal lens 14 has a characteristic that the arrangement of the liquid crystal molecules is changed with applied voltage, and the refractive index for light that passes through the liquid crystal lens 14 changes. Therefore, the focal length of the liquid crystal lens 14 is changed with applied voltage.

The optical change unit 15 is a member that changes the refractive index of the liquid crystal lens 14 by controlling the voltage that is applied to the liquid crystal lens 14. Therefore, the optical change unit 15 is a device that controls the optical properties of the liquid crystal lens 14 and controls the distance between the image forming position of the aerial three-dimensional image TI and the focal point F, and corresponds to the image forming position change unit in the present invention.

As illustrated in FIG. 3, the image displayed on the display surface 11 forms the aerial three-dimensional image TI at the position at the image forming distance Z through the liquid crystal lens 14. As in FIG. 1, the aerial three-dimensional image TI is located between the projection optical unit 20 and the focal point F, and the image forming position of the aerial three-dimensional image TI and the position of the focal point F are a distance ΔD apart from each other. Moreover, the light shielding unit 40 is placed between the focal point F and the three-dimensional image projection unit 12, and blocks the travel of the outside light concentrated at the focal point F toward the display surface 11.

When the optical change unit 15 controls the voltage that is applied to the liquid crystal lens 14 to change the image forming distance Z, the distance ΔD between the aerial three-dimensional image TI and the focal point F also changes, and the image forming position of the virtual image IM also changes.

Also in the embodiment, the image display unit 10 is placed farther than the focal point F of the projection optical unit 20, and forms the aerial three-dimensional image TI between the focal point F and the projection optical unit 20. Therefore, it is possible to prevent light from outside from being concentrated in the vicinity of the image display unit 10 and to suppress deterioration in the image display unit 10 due to the light from outside.

Moreover, the optical change unit 15 and the liquid crystal lens 14 are used as the image forming position change unit. It is therefore possible to change the distance ΔD between the image forming position of the aerial three-dimensional image TI and the focal point F without mechanically moving the image display unit 10 and then to change the image forming position of the virtual image IM, and to promote a reduction in the number of parts and space saving. Moreover, simply by the optical change unit 15 controlling the voltage that is applied to the liquid crystal lens 14, it is possible to change the optical properties of the liquid crystal lens 14 and to change the image forming position of the virtual image IM; therefore, it is possible to achieve power saving and high-speed operation.

### Modification of Second Embodiment

Next, a modification of the second embodiment of the present invention is described with reference to FIG. 4. Descriptions of contents overlapping with those of the first embodiment are omitted. FIG. 4 is a schematic diagram illustrating an example of changing the image forming position of the aerial three-dimensional image TI by means of a liquid crystal microlens array and the optical change unit in the image projection apparatus 100 according to the modification. As illustrated in FIG. 4, in the image projection apparatus 100 of the embodiment, the image display unit 10 includes the display surface 11 and a liquid crystal microlens array 16, and is configured in such a manner that the optical change unit 15 can change the refractive index of the liquid crystal microlens array 16.

The liquid crystal microlens array 16 is an optical member in which minute lens shapes filled with liquid crystal molecules are arranged in an array, and the refractive index of the liquid crystal molecules has anisotropy. Therefore, the liquid crystal microlens array 16 has a characteristic that the arrangement of the liquid crystal molecules is changed with applied voltage, and the refractive index for light that passes through changes. Therefore, the liquid crystal microlens array 16 is an optical member of which the focal length is changed with applied voltage, and corresponds to the liquid crystal lens in the present invention. The optical change unit 15 controls the voltage that is applied to the liquid crystal microlens array 16 to change the refractive index of the liquid crystal microlens array 16.

As illustrated in FIG. 4, the image displayed on the display surface 11 forms the aerial three-dimensional image TI at the position at the image forming distance Z through the liquid crystal microlens array 16. As in FIG. 1, the aerial three-dimensional image TI is located between the projection optical unit 20 and the focal point F, and the image forming position of the aerial three-dimensional image TI and the position of the focal point F are a distance ΔD apart from each other. Moreover, the light shielding unit 40 is placed between the focal point F and the three-dimensional image projection unit 12, and blocks the travel of the outside light concentrated at the focal point F toward the display surface 11.

When the optical change unit 15 controls the voltage that is applied to the liquid crystal microlens array 16 to change the image forming distance Z, the distance ΔD between the aerial three-dimensional image TI and the focal point F also changes, and the image forming position of the virtual image IM also changes.

Also in the modification, the image display unit 10 is placed farther than the focal point F of the projection optical unit 20, and forms the aerial three-dimensional image TI between the focal point F and the projection optical unit 20. Therefore, it is possible to prevent light from outside from being concentrated in the vicinity of the image display unit 10 and to suppress deterioration in the image display unit 10 due to the light from outside.

Moreover, the optical change unit 15 and the liquid crystal microlens array 16 are used as the image forming position change unit. It is therefore possible to change the distance ΔD between the image forming position of the aerial three-dimensional image TI and the focal point F without mechanically moving the image display unit 10 and then to change the image forming position of the virtual image IM, and to promote a reduction in the number of parts and space saving. Moreover, simply by the optical change unit 15 controlling the voltage that is applied to the liquid crystal microlens array 16, it is possible to change the optical properties of the liquid crystal microlens array 16 and to change the image forming position of the virtual image IM; therefore, it is possible to achieve power saving and high-speed operation.

### Third Embodiment

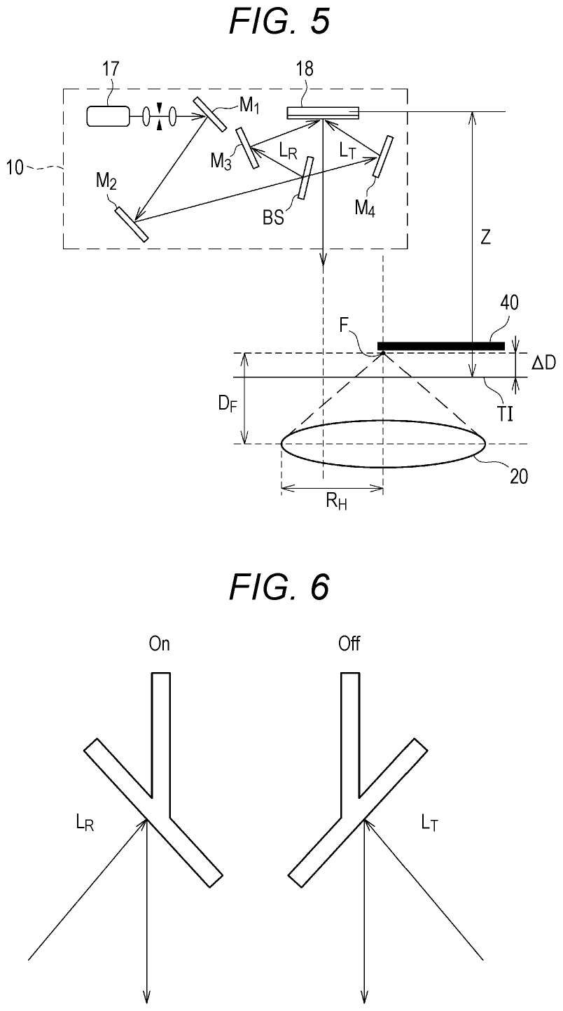

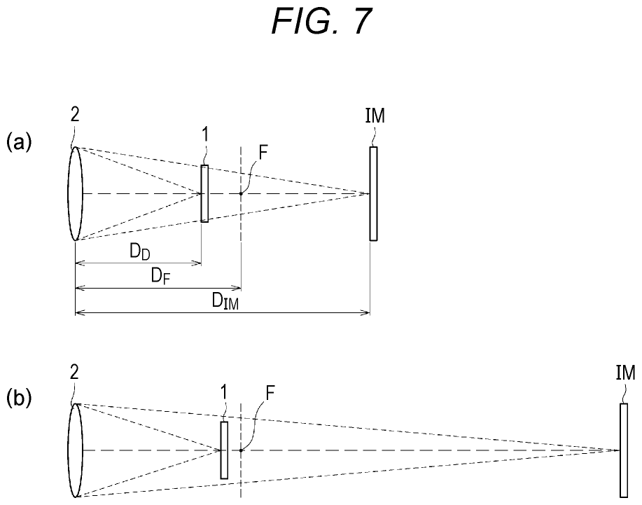

Next, a third embodiment of the present invention is described with reference to FIGS. 5 and 6. Descriptions of contents overlapping with those of the first embodiment are omitted. FIG. 5 is a schematic diagram illustrating an example of changing the image forming position of the aerial three-dimensional image TI by means of a hologram projection unit that uses a digital mirror device in the image projection apparatus 100 according to the embodiment. As illustrated in FIG. 5, in the image projection apparatus 100 of the embodiment, the image display unit 10 includes a laser light source 17, a digital mirror device 18 (DMD: Digital Mirror Device), mirrors M1 to M4, and a beam splitter BS to constitute the hologram projection unit.

The laser light source 17 is a light source that applies coherent light having a predetermined wavelength. Although the wavelength and configuration of the laser light source 17 are not limited, for example, a He—Ne laser or a semiconductor laser can be used as the laser light source 17. Moreover, the laser light source 17 may include optical members such as a collimating lens that converts laser light into parallel light, and an aperture that restricts the diameter of the laser light.

The digital mirror device 18 is an electronic component in which minute mirrors are placed in a matrix and can change the inclination angle to an on state or an off state. In the embodiment, the digital mirror device 18 functions as a spatial light modulator (SLM: Spatial Light Modulator) of the hologram projection unit, and reproduces interference fringes for hologram projection by controlling the turning on and off of the mirrors. Moreover, the digital mirror device 18 is driven by an unillustrated DMD controller, and the DMD controller calculates and displays an interference fringe with a computer-generated hologram (CGH: Computer-Generated Hologram) by computational processing such as a Gerchberg-Saxton (GS) algorithm. The example illustrated in FIG. 5 is an example in which the digital mirror device 18 is used as the spatial light modulator of the hologram projection unit. However, a known configuration such as a liquid crystal display device may be used.

The mirrors M1 to M4 are members that reflect the laser light applied from the laser light source 17. The beam splitter BS is an optical member that transmits 50% of the laser light and reflects 50% of the laser light, and splits the incident laser light into two beams.

As illustrated in FIG. 5, the laser light applied from the laser light source 17 is reflected by the mirrors M1 and M2 and is incident on the beam splitter BS. A reflected beam LR is incident on the mirror M3, and a transmitted beam LT is incident on the mirror M4. The beams of light incident on the mirrors M3 and M4 are reflected by the mirrors M3 and M4. The reflected beams of light are incident on the digital mirror device 18 at different angles, respectively. The light incident on the digital mirror device 18 is reflected by the interference fringe displayed on the digital mirror device 18 by the computer-generated hologram, and the aerial three-dimensional image TI is reproduced and formed at the position at the image forming distance Z. Therefore, the beams of light reflected by the mirrors M3 and M4 and being incident on the digital mirror device 18 are radiation of reproduced light in the hologram.

Here, in the computer-generated hologram, a hologram can be calculated and reproduced, including the position of the aerial three-dimensional image TI; therefore, the shape of the aerial three-dimensional image TI and the image forming distance Z can be changed simply by controlling the turning on and off of the micromirrors of the digital mirror device 18. Consequently, the distance ΔD between the aerial three-dimensional image TI and the focal point F also changes, and the image forming position of the virtual image IM also changes. Therefore, the hologram projection unit that uses the digital mirror device 18 corresponds to the optical change unit in the present invention. Moreover, when the aerial three-dimensional image TI that is an image reproduced by the hologram projection unit is formed, a conjugate image is formed behind the digital mirror device 18. However, the distance from the focal point F is long; therefore, there is little influence on the visibility of the viewer E.

FIG. 6 is a schematic diagram illustrating the reflection of the reflected beam LR and the transmitted beam LT on the digital mirror device 18. It is assumed that one of a pair of adjacent minute mirrors included in the digital mirror device 18 is in the on state, and the other is in the off state. At this point in time, the reflected beam LR incident on the micromirror in the on state and the transmitted beam LT incident on the micromirror in the off state are set in advance to be reflected in the same direction. Since the phases of the transmitted beam LT and the reflected beam LR are inverted, it is possible to cancel the 0th-order diffracted light and to double the light intensity of the aerial three-dimensional image TI that is the reproduced image.

Also in the embodiment, the image display unit 10 is placed farther than the focal point F of the projection optical unit 20, and forms the aerial three-dimensional image TI between the focal point F and the projection optical unit 20. Therefore, it is possible to prevent light from outside from being concentrated in the vicinity of the image display unit 10 and to suppress deterioration in the image display unit 10 due to the light from outside.

Moreover, the hologram projection unit that uses the digital mirror device 18 changes the image forming position of the aerial three-dimensional image TI. It is therefore possible to change the distance ΔD between the image forming position of the aerial three-dimensional image TI and the focal point F without mechanically moving the image display unit 10 and then to change the image forming position of the virtual image IM, and to promote a reduction in the number of parts and space saving.

### Fourth Embodiment

Next, a fourth embodiment of the present invention is described.

Descriptions of contents overlapping with those of the first embodiment are omitted. FIGS. 1 to 6 appearing in the first to third embodiments illustrate the example in which outside light incident on the projection optical unit 20 is concentrated at one focal point F. However, since the position of the focal point F changes according to the incident angle of the outside light, the focal positions where the outside light can be concentrated are distributed over a plane as indicated by the broken line in FIG. 1.

Therefore, it is preferable that the light shielding unit 40 be structured in such a manner as to shield the outside light in the largest possible region and not shield the light that the image display unit 10 applies to the projection optical unit 20 after forming the aerial three-dimensional image TI. Specifically, examples of the structure include the flat plate-shaped light shielding unit 40 that is placed in a large area between the image display unit 10 and the projection optical unit 20, and has an opening formed only in a region where light is applied from the image display unit 10.

Moreover, the outside light that adversely affects the image display unit 10 is sunlight in the daytime during which the sun is at high altitude, and light incident from the horizontal direction has a relatively small influence. In other words, the region where the light shielding unit 40 is required to shield outside light is in the vicinity of the focal point F of light incident at an angle from a high altitude, and there is little need to shield light incident from the horizontal direction or from below the horizontal direction. Therefore, as illustrated in FIG. 1, it is preferable to provide the light shielding unit 40 only in a region where outside light from a high altitude is concentrated. Moreover, the direction in which the virtual image IM is displayed is the horizontal direction, or the vicinity of the road surface below the horizontal direction, relative to the viewer E, and the image display unit 10 applies light, avoiding the light shielding unit 40 that shields the outside light from a high altitude; therefore, the virtual image IM can be excellently formed in the horizontal direction.

Moreover, FIGS. 1 to 6 illustrate the example in which the light shielding unit 40 is placed between the focal point F and the image display unit 10. However, the light shielding unit 40 may be placed between the focal point F and the aerial three-dimensional image TI, or between the focal point F and the projection optical unit 20, as long as it can shield the outside light.

The present invention is not limited to the above-mentioned embodiments, and various alterations can be made within the scope revealed in the claims, and embodiments obtained by combining technical means disclosed in different embodiments as appropriate are also included in the technical scope of the present invention.

The present international application claims a priority based on Japanese Patent Application No. 2020-168476 being a Japanese patent application filed on Oct. 5, 2020, the entire contents of which are incorporated herein by reference.

The above description of the specific embodiments of the present invention has been presented for the purpose of illustration. They are not intended to be exhaustive or to limit the present invention as it is in the form described. It is obvious to those skilled in the art that many modifications and alterations can be made in light of the above description.

### LIST OF REFERENCE SIGNS

100 Image projection apparatus
10 Image display unit
20 Projection optical unit
30 Transmission screen unit
40 Light shielding unit
11 Display surface
12 Three-dimensional image projection unit
13 Drive unit
14 Liquid crystal lens
15 Optical change unit
16 Liquid crystal microlens array
17 Laser light source
18 Digital mirror device

What is claimed is:

1. An image projection apparatus comprising:
a projection optical unit configured to project light from a focal position; and
an image display unit configured to apply light including image information to the projection optical unit, wherein
the image display unit is placed farther from the projection optical unit than the focal position is, and forms an image of the image information as an aerial three-dimensional image at an image forming position between the focal position and the projection optical unit.

2. The image projection apparatus according to claim 1, further comprising an image forming position change unit configured to change a distance between the image forming position and the focal position.

3. The image projection apparatus according to claim 2, wherein the image forming position change unit includes a drive unit that moves the image display unit in an optical axis direction.

4. The image projection apparatus according to claim 2, wherein the image forming position change unit includes an optical change unit that changes a distance from the image display unit to the image forming position.

5. The image projection apparatus according to claim 4, wherein the optical change unit includes a liquid crystal lens that changes the refractive index with applied voltage.

6. The image projection apparatus according to claim 4, wherein the optical change unit includes a hologram projection unit that uses a digital mirror device.

7. The image projection apparatus according to claim 1, wherein the projection optical unit includes a transmission lens.

8. The image projection apparatus according to claim 1, wherein the projection optical unit includes a concave reflector.

9. The image projection apparatus according to claim 1, wherein a light shielding unit that shields light is provided between the image display unit and the focal position.

10. The image projection apparatus according to claim 9, wherein the image display unit avoids the light shielding unit and forms the aerial three-dimensional image at the image forming position.

11. A vehicle information display apparatus comprising the image projection apparatus according to claim 1.
